(19) United States
(12) Patent Application Publication
(10) Pub. No.: US 2023/0313900 A1
(43) Pub. Date: Oct. 5, 2023

(54) VALVE

(71) Applicant: KYB Corporation, Tokyo (JP)

(72) Inventor: Takuya MIURA, Kanagawa (JP)

(73) Assignee: KYB Corporation, Tokyo (JP)

(21) Appl. No.: 18/191,157

(22) Filed: Mar. 28, 2023

(30) Foreign Application Priority Data
Mar. 30, 2022 (JP) 2022-057609

(51) Int. Cl. F16K 29/00; F16K 1/38

(52) U.S. Cl. CPC F16K 29/00; F16K 1/38; F16K 1/12

(57) ABSTRACT

A valve includes: a seat member having a supply passage through which working fluid is supplied; a valve body configured to be seated onto an annular seat portion of the seat member, the valve body being configured to close the supply passage; and a spring serving as a biasing member configured to bias the valve body towards the seat portion, wherein the valve body receives a biasing force from the spring, the biasing force containing a force component in the direction perpendicular to the center axis of the seat portion.

### TECHNICAL FIELD

The present invention relates to a valve.

### BACKGROUND ART

JP2017-101695A discloses a relief valve having a valve main body that is provided in a pressure oil chamber between a pressure oil port and a discharge oil port and that has a valve seat and a poppet valve body that opens and closes an oil path in the valve seat by being moved in the back and forward direction with respect to the valve seat. The valve body is biased by a spring towards the valve seat, and when the valve body is seated onto the valve seat, a flow of fluid from the pressure oil port to the discharge oil port is prohibited. When the oil pressure acting on the valve body from the pressure oil port side exceeds the relief pressure, the valve body is separated away from the valve seat, and thereby, the flow of the fluid from the pressure oil port to the discharge oil port is allowed.

### SUMMARY OF INVENTION

With the relief valve as described in JP2017-101695A, it is conceivable that, when the valve body is opened, a force acts on the valve body in the radial direction due to the fluid pressure of the working fluid, and the valve body is vibrated in the radial direction. Thus, there is a risk in that noise is caused when the valve body is opened.

An object of the present invention is to prevent occurrence of a noise in a valve when a valve body is opened.

According to an aspect of the present invention, a valve includes: a seat member having a supply passage through which working fluid is supplied; a valve body configured to be seated onto an annular seat portion of the seat member, the valve body being configured to close the supply passage; and a biasing member configured to bias the valve body towards the seat portion, wherein the valve body receives a biasing force from the biasing member, the biasing force containing a force component in a direction perpendicular to a center axis of the seat portion.

### BRIEF DESCRIPTION OF DRAWINGS

FIG. 1 is a schematic view of a cross-section of a valve according to an embodiment of the present invention.

FIG. 2 is a schematic view of a cross-section of the valve according to the embodiment of the present invention, and shows a state in which a valve body is opened.

FIG. 3 is a schematic view of a cross-section of the valve according to a first modification of the embodiment of the present invention.

FIG. 4 is a schematic view of a cross-section of the valve according to a third modification of the embodiment of the present invention.

FIG. 5 is a schematic view of a cross-section of the valve according to a fourth modification of the embodiment of the present invention.

FIG. 6 is a schematic view of a cross-section of the valve according to a fifth modification of the embodiment of the present invention.

### DESCRIPTION OF EMBODIMENTS

A valve 100 according to an embodiment of the present invention will be described with reference to the drawings.

The valve 100 is used as a relief valve that is opened when pressure of working oil reaches a set pressure, thereby preventing an abnormal increase of the pressure of the working oil. In this embodiment, although the working oil is used as working fluid, other fluid such as working water, compressed air, and so forth may also be used. In addition, the valve 100 may be other valve than the relief valve.

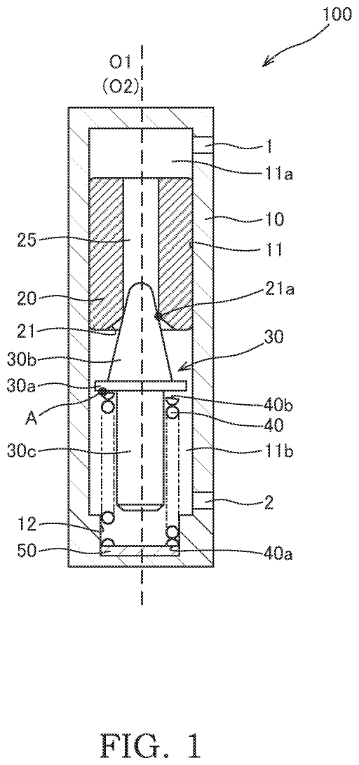

As shown in FIG. 1, the valve 100 is provided with: a case 10 that is provided with a supply port 1 and a discharge port 2; a seat member 20 that has a supply passage 25 through which the working oil is supplied from the supply port 1; a valve body 30 that closes the supply passage 25 by being seated onto an annular seat portion 21 of the seat member 20; and a spring 40 serving as a biasing member that biases the valve body 30 towards the seat portion 21.

An accommodating space 11 is provided within the case 10. The supply port 1 and the discharge port 2 respectively open at end portions of the accommodating space 11 on the longitudinal direction. The supply port 1 is connected to an external passage, and the discharge port 2 is connected to a tank (not shown). In the accommodating space 11, the seat member 20, the valve body 30, and the spring 40 are accommodated in this order from the supply port 1 side towards the discharge port 2 side. The accommodating space 11 is divided into two spaces by the seat member 20, and the case 10 is formed with a supply side space 11a that communicates with the supply port 1 and a discharge side space 11b that communicates with the discharge port 2. In the case 10, a support hole 12 serving as a support portion is provided so as to face the discharge side space 11b. An end portion of the spring 40 on the opposite side from the valve body 30 is inserted into the support hole 12, and thereby, the support hole 12 supports an outer circumference of the end portion of the spring 40. The support hole 12 is provided such that the inner diameter thereof is substantially the same as the outer diameter of the spring 40. A washer 50 that supports the spring 40 is provided on a bottom surface of the support hole 12. The support portion is not limited to the support hole 12, and the support portion may be a projected portion that is inserted into the spring 40 and supports the spring 40 from the inner circumference side.

The seat member 20 is formed to have a cylinder shape and is fixed by being press-fitted to the accommodating space 11 of the case 10. With such a configuration, the flow of the working oil between an outer circumferential surface of the seat member 20 and an inner circumferential surface of the accommodating space 11 is shut off, and as described above, the accommodating space 11 is divided into the supply side space 11a and the discharge side space 11b. The supply passage 25 is a through hole having a circular cross-sectional shape that is formed by penetrating through the center of the seat member 20 in the axial direction. The supply passage 25 faces the supply side space 11a and the discharge side space 11b, and thereby, both spaces are communicated therethrough. A surface of the seat member 20 facing the discharge side space 11b is provided with the annular seat portion 21 onto which the valve body 30 is seated. The seat portion 21 is provided so as to have a tapered shape in which the inner diameter is increased towards an end portion of the supply passage 25 facing the discharge side space 11b. The center axis O1 of the seat portion 21 is provided so as to match with the center axis O2 of the support hole 12 of the case 10.

The valve body 30 is formed so as to have a substantially columnar shape and is provided such that the center axis thereof is coaxial with the center axis O1 of the seat portion 21 of the seat member 20. The valve body 30 has: a disc-shaped flange portion 30a; a conical valve portion 30b that is provided so as to project out in the axial direction from one end surface of the flange portion 30a towards the seat portion 21; and a columnar projecting portion 30c that is provided so as to project out in the axial direction from the other end surface of the flange portion 30a. The flange portion 30a is provided such that both end surfaces extend in the direction perpendicular to the center axis O1 of the seat portion 21. A first end surface 40b of the compressed spring 40 is brought into contact with the flange portion 30a. With such a configuration, the valve body 30 is biased towards the seat portion 21 of the seat member 20. A tip end portion of the valve portion 30b is inserted into the supply passage 25, and thereby, the valve portion 30b is seated onto the seat portion 21. Specifically, the valve portion 30b is seated onto the seat portion 21 as a boundary portion 21a of the seat portion 21 with the supply passage 25 is brought into annular line contact with a side surface of the valve portion 30b. Thereby, the communication between the supply side space 11a and the discharge side space 11b through the supply passage 25 is shut off. The projecting portion 30c is provided inside the spring 40. Because the spring 40 is supported from the inner side by the projecting portion 30c, the spring 40 is prevented from falling off from the valve body 30.

The spring 40 is provided between the flange portion 30a of the valve body 30 and the washer 50 by being compressed. The spring 40 is provided so as to be coaxial with the support hole 12 of the case 10, the seat portion 21 of the seat member 20, and the valve body 30, thereby biasing the valve body 30 towards the seat portion 21. The spring 40 is provided such that an end surface 40a, which is in contact with the washer 50, extends, together with the washer 50, in the direction perpendicular to the center axis O1 of the seat portion 21. In addition, the spring 40 is provided such that the end surface 40b, which is in contact with the flange portion 30a of the valve body 30, extends so as to be inclined with respect to the direction parallel to the center axis O1 of the seat portion 21 and the direction perpendicular to the center axis O1. Specifically, in the spring 40, the end surface 40b is inclined from the one side towards the other side in a constant manner. In FIG. 1, the spring 40 is formed so as to be shorter on the discharge port 2 side, and thereby, the end surface 40b is inclined down towards the right. The end surface 40b is processed by cutting, etc. The end surface 40b of the spring 40 is inclined with respect to the flange portion 30a of the valve body 30. Thus, only a part of the spring 40 in the circumferential direction (only on the left side in FIG. 1), but not a whole part thereof in the circumferential direction, comes into contact with the flange portion 30a to bias the valve body 30.

The force in the direction along the center axis O1 of the seat portion 21 and the force in the direction perpendicular to the center axis O1 of the seat portion 21 respectively act on the valve body 30 from a contacting part A of the valve body 30 with the spring 40. In FIG. 1, because the end surface 40b of the spring 40 is inclined down towards the right, “the force in the direction perpendicular to the center axis O1 of the seat portion 21” acting on the valve body 30 is the force directed towards the right in FIG. 1. Thus, the valve body 30 is biased towards the seat portion 21, and at the same time, the valve body 30 is biased towards the inner circumferential surface of the supply passage 25 (towards the right side in FIG. 1). As described above, the valve body 30 receives, from the spring 40, the biasing force containing a force component in the direction along the center axis O1 of the seat portion 21 and the force component in the direction perpendicular to the center axis O1 of the seat portion 21. Because the valve body 30 receives the above-described biasing force from the spring 40 at the position away from the center axis of its own, there is a tendency for the valve body 30 to rotate in the clockwise direction about the contacting part A with the spring 40 in FIG. 1. However, in a state in which the valve body 30 is not opened, due to the frictional force acting at the annular contacting part between the valve portion 30b and the seat portion 21, the valve body 30 is not rotated and its posture is maintained.

In the valve 100, when the pressure in the supply side space 11a reaches the relief pressure that is set in accordance with the biasing force of the spring 40 in the direction along the center axis O1 of the seat portion 21, the valve portion 30b of the valve body 30 is separated away from the seat portion 21 of the seat member 20, and thereby, the valve body 30 is opened. Thus, the working oil in the supply side space 11a is guided to the discharge side space 11b through the supply passage 25 and is discharged to the tank through the discharge port 2.

In the relief valve in which the end surface of the spring coming into contact with the valve body extends in the direction perpendicular to the center axis of the seat portion of the seat member, it is conceivable that, when the valve body is opened, the force acts on the valve body in the radial direction due to the fluid pressure of the working oil, and the valve body is vibrated in the radial direction. Thus, there is a risk in that a noise is caused when the valve body is opened.

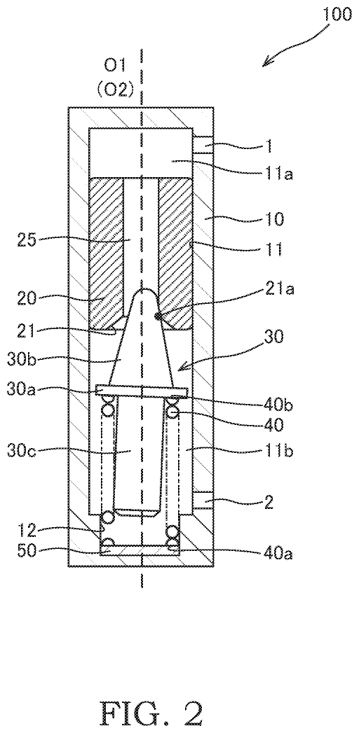

In contrast, in the valve 100 of this embodiment, the biasing force in the direction along the center axis O1 of the seat portion 21 and the biasing force in the direction perpendicular to the center axis O1 of the seat portion 21 act on the valve body 30. Therefore, as shown in FIG. 2, as the pressure in the supply side space 11a reaches the relief pressure, the valve body 30 is moved towards the spring 40, and at the same time, the valve body 30 is tilted towards the inner circumferential surface of the supply passage 25, and thereby, the valve portion 30b is pressed against the seat portion 21. In other words, when the valve body 30 is opened, only a part of the valve portion 30b (on the left side in FIG. 2) is separated away from the seat portion 21, and the flow of the working oil through a gap between the valve portion 30b and the seat portion 21 is allowed. On the other hand, a part of the valve portion 30b (on the right side in FIG. 2) is always pressed against the seat portion 21 (specifically, the boundary portion 21a of the seat portion 21 with the supply passage 25) through the motion of the valve 100. As described above, in the valve 100, even if the valve body 30 is opened and the working oil is guided from the supply passage 25, the valve portion 30b is pressed against the seat member 20 by the spring 40 in the direction perpendicular to the center axis O1 of the seat portion 21. Therefore, the vibration of the valve body 30 in the radial direction is prevented, and so, it is possible to prevent occurrence of the noise when the valve body 30 is opened.

In addition, in the valve 100 of this embodiment, the end surface 40b of the spring 40 is made to incline with respect to the direction perpendicular to the center axis O1 of the seat portion 21, and thereby, the vibration of the valve body 30 in the radial direction is prevented. In other words, it is possible to prevent the occurrence of the noise when the valve body 30 is opened without increasing the number of parts by using an existing spring for a conventional valve by processing it.

The inner diameter of the spring 40 is set so as not to come into contact with the projecting portion 30c when the valve body 30 is tilted. With such a configuration, the prohibition by the spring 40 of the tilting of the valve body 30 when the valve body 30 is opened is prevented.

In addition, it is preferred that the end surface 40b of the spring 40 be inclined within a range of 4°+/−1° relative to the direction perpendicular to the center axis O1 of the seat portion 21. With such a configuration, it is possible to prevent the occurrence of the noise when the valve body 30 is opened without causing deterioration of an installability of the valve body 30 to the seat member 20 in an assembly of the valve 100. However, the inclination of the end surface 40b may not fall into the range of 4°+/−1°.

According to the above-described embodiment, following operational advantages are afforded.

In the valve 100, the biasing force in the direction along the center axis O1 of the seat portion 21 and the biasing force in the direction perpendicular to the center axis O1 of the seat portion 21 act on the valve body 30. Therefore, even if the valve body 30 is opened and the working oil is guided from the supply passage 25, the valve portion 30b is pressed against the seat member 20 by the spring 40 perpendicularly to the center axis O1 of the seat portion 21. Thus, the vibration of the valve body 30 in the radial direction is prevented, and so, it is possible to prevent the occurrence of the noise when the valve body 30 is opened.

The following modifications also fall within the scope of the present invention, and it is also possible to combine the configurations shown in the modifications with the configurations described in the above embodiment, or to combine the configurations described in the following different modifications together.

<First Modification>

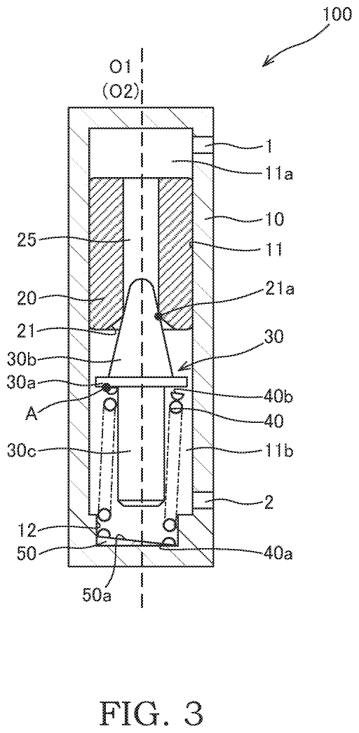

In the above-mentioned embodiment, the first end surface 40b of the spring 40 is processed by the cutting, etc., and thereby, the first end surface 40b is provided so as to be inclined with respect to the direction perpendicular to the center axis O1 of the seat portion 21. Instead of this configuration, as shown in FIG. 3, a first end surface 50a of the washer 50, which is provided on the bottom surface of the support hole 12 of the case 10, may be processed by the cutting, etc., and thereby, the end surface 50a may be provided so as to be inclined with respect to the direction perpendicular to the center axis O1 of the seat portion 21. Specifically, in FIG. 3, the end surface 50a of the washer 50 is inclined with respect to the direction perpendicular to the center axis O1 of the seat portion 21 such that it is inclined down towards the right. The spring 40 is provided such that both of the end surfaces 40a and 40b are not inclined with respect to the direction perpendicular to the center axis of its own and such that both of the end surfaces 40a and 40b extend in parallel with each other. The spring 40 is provided on the end surface 50a of the washer 50, and both of the end surfaces 40a and 40b thereof are inclined with respect to the direction perpendicular to the center axis O1 of the seat portion 21. With such a configuration, similarly to the present embodiment, the end surface 40b of the spring 40 is inclined with respect to the flange portion 30a, and only the part of the spring 40 in the circumferential direction (only on the left side in FIG. 3) comes into contact with the flange portion 30a to bias the valve body 30. Therefore, because the biasing force in the direction along the center axis O1 of the seat portion 21 and the biasing force in the direction perpendicular to the center axis O1 of the seat portion 21 act on the valve body 30, similarly to the present embodiment, the vibration of the valve body 30 in the radial direction is prevented. As described above, by processing the end surface 50a of the washer 50, the vibration of the valve body 30 in the radial direction is easily prevented.

<Second Modification>

It may be possible to employ a configuration in which the end surface 40b of the spring 40 is not inclined, and the washer 50 according to the first modification is provided between the end surface 40b of the spring 40 and the flange portion 30a of the valve body 30. In this modification, the washer is inclined with respect to the flange portion 30a, and only a part thereof in the circumferential direction comes to contact with the flange portion 30a. The valve body 30 is then biased by the spring 40 via the washer. Therefore, because the biasing force in the direction along the center axis O1 of the seat portion 21 and the biasing force in the direction perpendicular to the center axis O1 of the seat portion 21 act on the valve body 30, similarly to the present embodiment, the vibration of the valve body 30 in the radial direction is prevented.

<Third Modification>

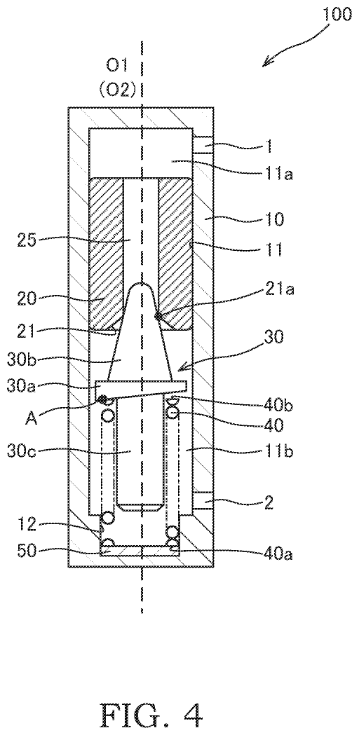

As shown in FIG. 4, it may be possible to employ a configuration in which the end surface 40b of the spring 40 is not inclined, and an end surface of the flange portion 30a of the valve body 30 in contact with the spring 40 is inclined with respect to the direction perpendicular to the center axis O1 of the seat portion 21. With such a configuration, similarly to the present embodiment, the end surface 40b of the spring 40 is inclined with respect to the flange portion 30a, and only the part of the spring 40 in the circumferential direction (only on the left side in FIG. 4) comes into contact with the flange portion 30a to bias the valve body 30. Therefore, because the biasing force in the direction along the center axis O1 of the seat portion 21 and the biasing force in the direction perpendicular to the center axis O1 of the seat portion 21 act on the valve body 30, similarly to the present embodiment, the vibration of the valve body 30 in the radial direction is prevented.

<Fourth Modification>

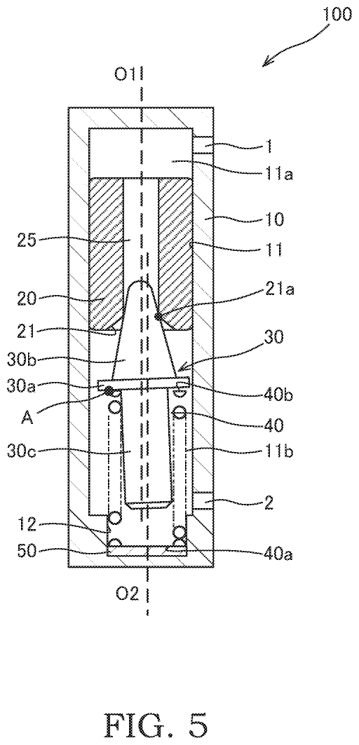

As shown in FIG. 5, the end surface 40b of the spring 40 may not be inclined, and the center axis O1 of the seat portion 21 of the seat member 20 and the center axis O2 of the support hole 12 of the case 10 may be provided so as to be deviated from each other. In other words, the center axis O1 of the seat portion 21 and the center axis of the spring 40 may be provided so as to be deviated from each other. In this description, the phrase “provided so as to be deviated from each other” specifically refers to a state in which the center axis O1 of the seat portion 21 and the center axis O2 of the support hole 12 are provided in parallel with each other such that a gap of a predetermined distance is formed therebetween. The center axis O2 of the support hole 12 is provided so as to be deviated from the center axis O1 of the seat portion 21 to the extent that the valve body 30 can be fitted to the seat member 20. In FIG. 5, the center axis O2 of the support hole 12 is provided so as to be deviated to the right side from the center axis O1 of the seat portion 21. With such a configuration, the valve body 30 is seated onto the seat portion 21 in such a manner that the center axis thereof is deviated from the center axis O1 of the seat portion 21. Thus, the flange portion 30a of the valve body 30 is inclined with respect to the direction perpendicular to the center axis O1 of the seat portion 21. With such a configuration, similarly to the present embodiment, the end surface 40b of the spring 40 is inclined with respect to the flange portion 30a, and only the part of the spring 40 in the circumferential direction (only on the left side in FIG. 5) comes into contact with the flange portion 30a to bias the valve body 30. Therefore, because the biasing force in the direction along the center axis O1 of the seat portion 21 and the biasing force in the direction perpendicular to the center axis O1 of the seat portion 21 act on the valve body 30, similarly to the present embodiment, the vibration of the valve body 30 in the radial direction is prevented. As described above, by adjusting the positional relationship between the seat portion 21 and the spring 40, the vibration of the valve body 30 in the radial direction is easily prevented.

<Fifth Modification>

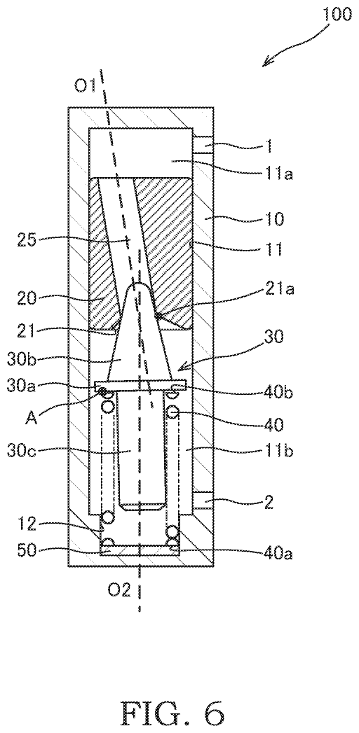

As shown in FIG. 6, the end surface 40b of the spring 40 may not be inclined, and the supply passage 25 and the seat portion 21 may be provided so as to be inclined with respect to the center axis O2 of the support hole 12. The valve body 30 is seated onto the seat portion 21 in such a manner that the valve portion 30b is inserted along the inner circumferential surface of the supply passage 25 so as to be tilted. Thus, the flange portion 30a of the valve body 30 is inclined with respect to the direction perpendicular to the center axis O2 of the support hole 12. With such a configuration, similarly to the present embodiment, the end surface 40b of the spring 40 is inclined with respect to the flange portion 30a, and only the part of the spring 40 in the circumferential direction (only on the left side in FIG. 6) comes into contact with the flange portion 30a to bias the valve body 30. Therefore, because the biasing force in the direction along the center axis O1 of the seat portion 21 and the biasing force in the direction perpendicular to the center axis O1 of the seat portion 21 act on the valve body 30, similarly to the present embodiment, the vibration of the valve body 30 in the radial direction is prevented.

The configurations, operations, and effects of the embodiment of the present invention configured as described above will be collectively described.

The valve 100 includes: the seat member 20 having the supply passage 25 through which the working fluid is supplied; the valve body 30 configured to be seated onto the annular seat portion 21 of seat member 20, the valve body 30 being configured to close the supply passage 25; and the spring 40 serving as the biasing member configured to bias the valve body 30 towards the seat portion 21, wherein the valve body 30 receives the biasing force from the spring 40, the biasing force containing the force component in the direction perpendicular to the center axis O1 of the seat portion 21.

With this configuration, the biasing force in the direction along the center axis O1 of the seat portion 21 and the biasing force in the direction perpendicular to the center axis O1 of the seat portion 21 act on the valve body 30. Therefore, even if the valve body 30 is opened and the working fluid is guided through the supply passage 25, a part of the valve body 30 is pressed against the seat member 20 by the spring 40. With such a configuration, the vibration of the valve body 30 in the radial direction is prevented.

In addition, the spring 40 is provided such that the end surface 40b in contact with the valve body 30 is inclined with respect to the direction perpendicular to the center axis O1.

With this configuration, by processing the end surface 40b of the spring 40, the vibration of the valve body in the radial direction is easily prevented.

In addition, in the valve 100, the center axis O1 of the seat portion 21 and the center axis of the spring 40 are provided so as to be deviated from each other.

With this configuration, by adjusting the positional relationship between the seat portion 21 and the spring 40, the vibration of the valve body 30 in the radial direction is easily prevented.

Embodiments of the present invention were described above, but the above embodiments are merely examples of applications of the present invention, and the technical scope of the present invention is not limited to the specific constitutions of the above embodiments.

With respect to the above description, the contents of application No. 2022-057609, with a filing date of Mar. 30, 2022 in Japan, are incorporated herein by reference.

1. A valve comprising:
a seat member having a supply passage through which working fluid is supplied;
a valve body configured to be seated onto an annular seat portion of the seat member, the valve body being configured to close the supply passage; and
a biasing member configured to bias the valve body towards the seat portion, wherein
the valve body receives a biasing force from the biasing member, the biasing force containing a force component in a direction perpendicular to a center axis of the seat portion.

2. The valve according to claim 1, wherein
the biasing member is provided such that an end surface of the biasing member in contact with the valve body is inclined with respect to a direction perpendicular to the center axis.

3. The valve according to claim 1, wherein
the center axis of the seat portion and a center axis of the biasing member are provided so as to be deviated from each other.
